(19) United States
(12) Patent Application Publication
(10) Pub. No.: US 2009/0293077 A1
(43) Pub. Date: Nov. 26, 2009

(54) OPTICAL DISK DEVICE

(76) Inventors: Hisahiro MIKI, Chigasaki (JP); Yoshiyuki TANAKA, Kawasaki (JP); Yoichi NARUI, Matsudo (JP); Ikuo NISHIDA, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/425,431

(22) Filed: Apr. 17, 2009

(30) Foreign Application Priority Data
May 26, 2008 (JP) 2008-137030

(51) Int. Cl. G11B 17/04

(52) U.S. Cl. 720/601; G9B/17.013

(57) ABSTRACT

An optical disk device in which the thickness of the device is not increased, and interference between the bottom surface of an optical pickup unit (OPU) and a bottom case of the device is prevented upon emergency ejection of an optical disk without moving the optical pickup unit to an outermost peripheral position of the disk in the event of abnormality such as power shutdown during an operation in the optical disk device. A support mechanism having a coil spring is provided at shaft-holders in three of four positions of a guide main shaft and a guide sub shaft to support an OPU, to perform skew adjustment. In another position, a support mechanism having a plate spring is provided such that, upon emergency ejection, the interference between the bottom surface of the OPU and the bottom case is mitigated.

### CLAIM OF PRIORITY

The present application claims priority from Japanese patent application serial no. JP 2008-137030, filed on May 26, 2008, the content of which is hereby incorporated by reference into this application.

### BACKGROUND

1. Technical Field

The present invention relates to an optical disk device to drive an optical disk which is used as a recording medium for an information apparatus such as a computer system and a video recording device such as a DVD (Digital Versatile Disk) camera/recorder and a BD (Blu-ray Disk) camera/recorder.

2. Related Art

In recent years, as an optical disk device, incorporated in a personal computer (PC), a DVD camera/recorder, a BD camera/recorder and the like, a thin type device is widely used. As a conventional method for loading an optical disk such as a DVD or a BD in the optical disk device for a recording/reproducing operation, a tray-type device in which an optical disk placed on a disk tray is loaded and ejected is popularly used.

However, in accordance with requirements of downsizing and thinning of PCs and camera/recorders, recently slim slot type optical disk devices without tray are increased. When a user inserts the most part of an optical disk into a slot in a front surface of the device, a loading mechanism of the device is actuated, to guide the optical disk inside. Then in a position where the center of the optical disk approximately corresponds with a shaft center of a spindle motor, the spindle motor is lifted up and the optical disk is clamped onto a turn table integral with the spindle motor. During this operation, an optical pickup unit (OPU) is withdrawn to an outermost peripheral side of the optical disk, not to disturb the loading operation.

In this device, in preparation for abnormality such as power shutdown during an operation, a so-called emergency eject mechanism to eject the optical disk during an operation is required. Upon ejection, the spindle motor is moved down. At this time, the operation may be disturbed in accordance with the position of the OPU. To address this problem, Japanese Published Unexamined Patent Application No. 2005-190554 discloses a method enabling emergency ejection when an operation command has not been received for a predetermined or longer period or when the power is changed, by setting the OPU to an eject stand-by status in which the OPU is moved to an outermost peripheral position.

### SUMMARY

Conventionally, in many cases, the OPU is moved upon emergency ejection. However, to quickly perform ejection, it is desirable that, e.g., ejection is performed without moving the OPU to the most outermost peripheral position. Further, at that time, it is desirable that such quick ejection is realized by a method which does not disturb thinning of the device.

The present invention has an object to address these problems, and to provide an optical disk device, in which emergency ejection can be performed without moving the OPU to the outermost peripheral position, and in which a thickness of the device is not increased for the purpose of the emergency ejection.

According to one aspect of the present invention, the foregoing object is attained by providing an optical disk device comprising: an optical pickup unit that records/reproduces a signal; a spindle motor that rotate-drives a disk-shaped recording medium; a turn table, rotated by the spindle motor, that clamps the recording medium; a slot loading mechanism that clamps the inserted recording medium on the turn table, or clamp-releases the recording medium from the turn table and ejects the recording medium to outside the device; a first moving mechanism that rotatably moves the spindle motor and the turn table upward/downward; a skew adjustment mechanism having a guide main shaft and a guide sub shaft to support the optical pickup unit; a second moving mechanism that moves the optical pickup unit to a predetermined position on the recording medium; and an armored case, wherein the skew adjustment mechanism has a mechanism to mitigate interference between the optical pickup unit and the armored case, regardless of the position of the optical pickup unit, upon emergency ejection to eject the recording medium clamped on the turn table to the outside the device.

In accordance with the present invention, emergency ejection of an optical disk can be realized without moving the OPU to the outermost peripheral position of the device, and further, the present invention can contribute to realization of a thin, small and lightweight PC and camera/recorders.

### BRIEF DESCRIPTION OF THE DRAWINGS

These and other features, objects and advantages of the present invention will become more apparent from the following description when taken in conjunction with the accompanying drawings wherein:

FIG. 1A is a perspective view showing an outer appearance of an optical disk drive;

FIG. 1B is a perspective view showing a feeding mechanism of the optical disk drive in FIG. 1A;

FIGS. 2A and 2B are bottom plan views showing the feeding mechanism in an embodiment;

FIGS. 3A and 3B are perspective views showing the feeding mechanism in the embodiment;

FIGS. 4A and 4B are perspective views showing the feeding mechanism in the embodiment;

FIGS. 5A and 5B are plan views showing the optical disk drive; and

FIGS. 5C and 5D are side views showing the optical disk drive.

### DETAILED DESCRIPTION OF EMBODIMENTS

Hereinbelow, a preferred embodiment of the present invention will be described in accordance with the accompanying drawings.

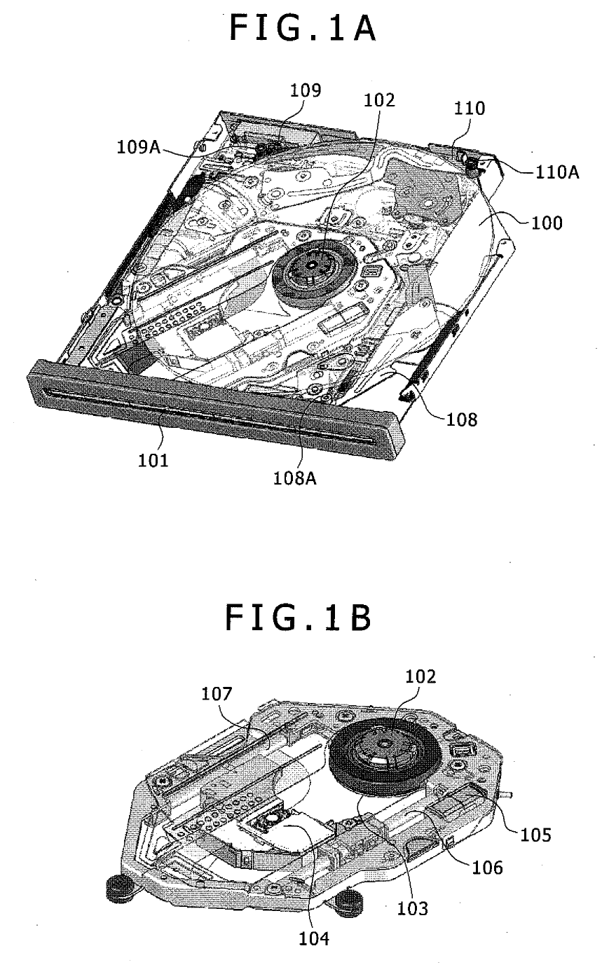

FIG. 1A is a perspective view showing an outer appearance of a slim slot-in type optical disk drive in which a top case is removed. FIG. 1B is a perspective view showing a feeding mechanism of the optical disk drive having a spindle motor, a turn table, an OPU and the like. In FIG. 1A, an optical disk 100 is inserted from a slot 101 and clamped on a turn table 102. The optical disk 100 is tentatively transparent for viewing of the inner parts of the optical disk drive. By rotation of a spindle motor 103, the optical disk 100 clamped on the turn table 102 is rotated. In accordance with rotation of a slide motor 105, an OPU 104 moves along a guide main shaft 106 and a guide sub shaft 107 in a radial direction of the optical disk 100, and performs information recording/reproducing in a designated position. As described above, generally, during loading from insertion of the optical disk 100 to clamping of the optical disk 100 on the turn table 102, or during unloading of these operations in a reverse manner, the OPU 104 is withdrawn to an outermost peripheral position of the optical disk, i.e., a position close to the slot 101 in FIG. 1A.

An insert arm 108 having an insert roller 108A, an eject arm 109 having an eject roller 109A, and a disk lever 110 having a disk roller 110A are constituent elements for loading/unloading (eject) of the optical disk 100. The insert roller 108A is driven by the insert arm 108 upon loading, pushes an outer peripheral side surface of the optical disk 100 to insert-move the optical disk in an inner direction of the device. Upon completion of the loading, the insert roller 108A is brought into contact with the outer peripheral side surface of the optical disk 100 and supports the optical disk. The eject roller 109A is also brought into contact with the outer peripheral side surface of the optical disk 100 and supports the optical disk upon completion of the loading of the optical disk. Upon unloading, the eject roller 109A is driven by the eject arm 109, pushes the outer peripheral side surface of the optical disk 100 to eject-move the optical disk to an outer direction of the device. The disk roller 110A is driven by the disk lever 110 upon loading, brought into contact with the outer peripheral side surface of the optical disk 100 and supports the optical disk, and prevents displacement of the optical disk from a predetermined position.

As the optical disk 100 supported with these rollers upon loading is positioned such that its center approximately corresponds with the center of the turn table 102, thereafter, the turn table 102 and the spindle motor 103 rise, and the optical disk 100 is clamped on the turn table 102. Upon unloading, the turn table 102 and the spindle motor 103 are moved down, and the optical disk 100 is clamp-released.

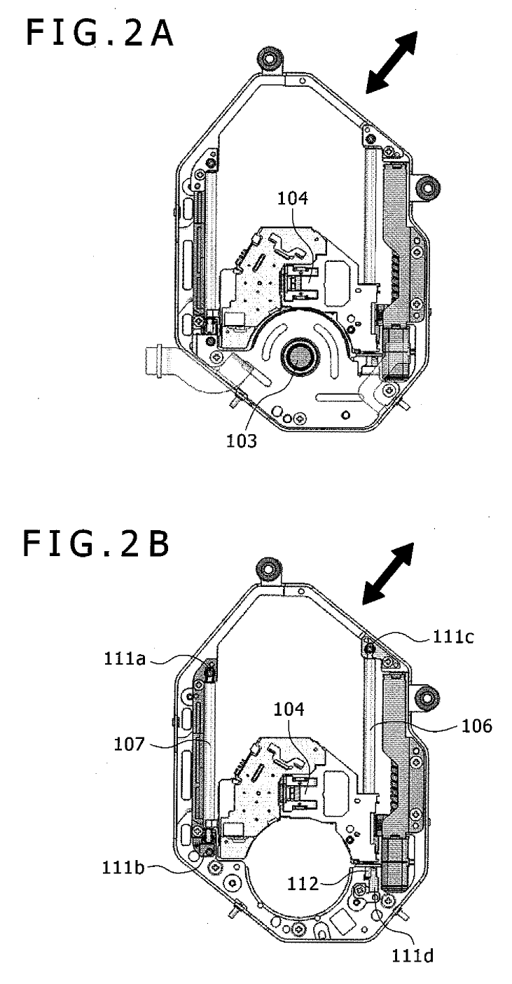

Next, a skew adjustment mechanism of the OPU 104 will be described. The skew adjustment is previously adjusting a three-dimensional attachment angle so as to set the OPU 104 to be appropriately opposite to the optical disk 100. The skew adjustment mechanism will be described with reference to FIGS. 2A and 2B.

FIGS. 2A and 2B are bottom plan views showing the feeding mechanism shown in FIG. 1B. FIG. 2A shows a case where the spindle motor 103 is provided, and FIG. 2B, a case where the spindle motor 103 is removed. In these figures, a bidirectional arrow indicates moving directions of the optical disk 100 upon loading and unloading. As described above, the OPU 104 is held from both sides with the guide main shaft 106 and the guide sub shaft 107 and moved in upward and downward directions in the figures. Screws 111a to 111c each having a coil spring for height adjustment are provided at an upper end of the guide main shaft 106 on the drawing and both ends of the guide sub shaft 107. The screws are fixed in respective optimum positions upon manufacture, thereby the above-described skew adjustment can be made. As coil springs are used, even after the skew adjustment, the direction of the OPU 104 is changed by application of an external force to the guide main shaft 106 and the guide sub shaft 107.

As the three-dimensional attachment angle can be arbitrarily set by adjustment in the above-described three positions, conventionally, a lower end of the guide main shaft 106 on the drawing is fixed, and the above-described adjustment mechanism is not provided.

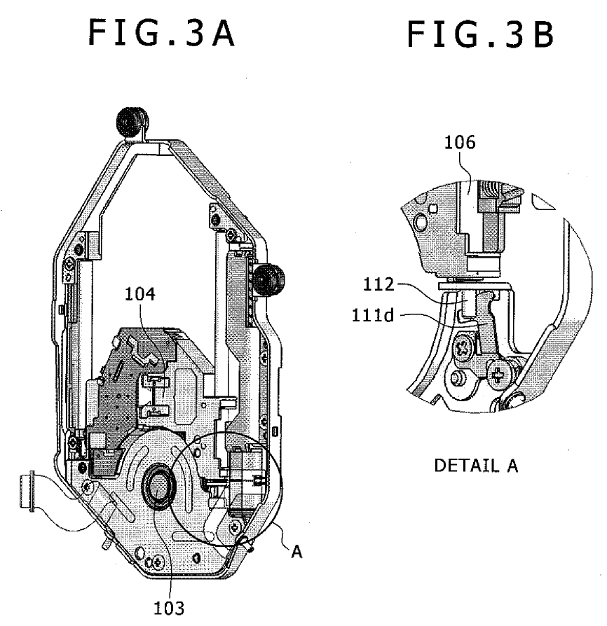

In the present embodiment, the skew adjustment mechanism mitigates interference between the OPU and the bottom case upon disk emergency ejection, which realizes emergency ejection without disturbance in thinning of the device. Particularly, in FIG. 2B, a plate spring 111d, for example, in contact with the lever 112 at the end of the guide main shaft 106, is provided at the lower end of the guide main shaft 106 on the drawing such that the height relation between the OPU 104 and the spindle motor 103 can also be changed. Accordingly, emergency ejection in a status, where the OPU 104 is not on the outermost peripheral side of the disk as described later, can be realized without increasing the thickness of the optical disk drive. Hereinbelow, this arrangement will be described using FIGS. 3A and 3B, FIGS. 4A and 4B, and FIGS. 5A to 5D.

FIG. 3A is a perspective view showing the bottom surface side of the feeding mechanism in FIG. 2A, from a diagonally right upper direction. FIG. 3B is an enlarged view of a lower portion of the guide main shaft 106 on the drawing in a circle denoted by A. A force to a bottom surface direction of the device is applied with the plate spring 111d to the lever 112 at the end of the guide main shaft 106, and is balanced.

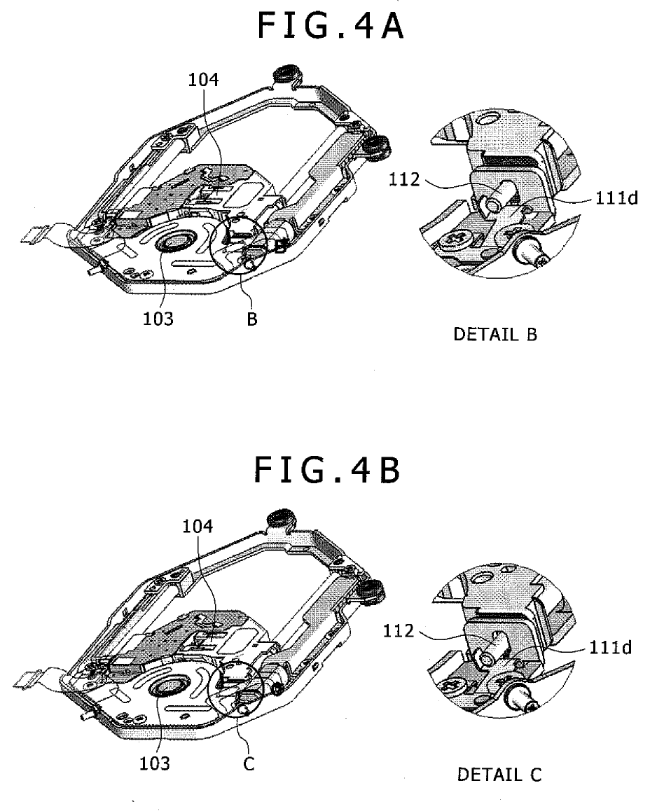

FIG. 4A is a perspective view showing the bottom surface side of the feeding mechanism in FIG. 2A from a diagonally right lower direction. FIG. 4A shows a normal status where optical disk emergency ejection is not performed. FIG. 4B shows a status upon emergency ejection operation.

In the former status, as particularly shown in the enlarged view denoted by B, the lever 112 is pushed with the plate spring 111d and positioned on the upper side on the drawing, i.e., on the bottom surface side of the device. Further, as shown in the figure, the bottom surface of the OPU 104 is generally on the bottom surface side of the device rather than the bottom surface of the spindle motor 103 due to parts mounted on the OPU.

Upon emergency ejection in the former status, to release the clamped status of the optical disk from the turn table, the spindle motor 103 is moved to the bottom surface side of the device, i.e., to the upper side in FIGS. 4A and 4B. At this time, in the present embodiment, as particularly shown in the enlarged view denoted by C, the plate spring 111d and the lever 112 are pushed up, and balanced in a new point. At this time, as the OPU 104 is pushed up with the plate spring 111d, the amount of movement to the bottom surface side of the device is smaller than that of the spindle motor 103.

On the other hand, in the case of the conventional device without the mechanism using the lever 112 and the plate spring 111d in the present embodiment, in which the lower end of the guide main shaft 106 on the drawing is fixed, as the OPU 104 and the spindle motor 103 are integrally moved, the bottom surface of the OPU 104 may interfere with e.g. the bottom case in the bottom surface of the device.

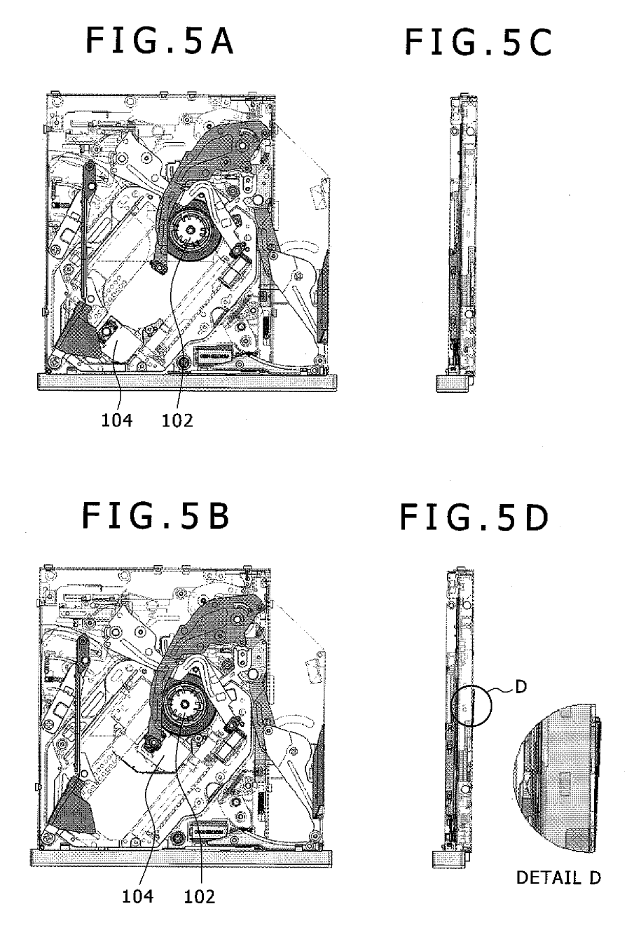

The problem of interference between the OPU and the bottom case will be described using FIGS. 5A to 5D. FIGS. 5A and 5B are plan views showing the optical disk drive from an upper side of the optical disk drive. FIGS. 5C and 5D are side views showing the optical disk drive from the right side of the optical disk drive. Further, FIGS. 5A and 5C show a status upon normal loading or unloading, and FIGS. 5B and 5D, a status upon emergency ejection. Note that the optical disk and the bottom case are not shown in these figures.

Upon normal loading or unloading, as shown in FIG. 5A, the OPU 104 is positioned on the outermost peripheral side of the optical disk, i.e., the lower side on the drawing. Accordingly, even when the spindle motor 103 and the turn table 102 are moved to the bottom surface side of the device, the amount of movement of the OPU 104 to the bottom surface side is small. Accordingly, as shown in FIG. 5C, the problem that the constituent elements such as the OPU 104 are projected to the bottom surface side of the device and interfere with the bottom case can be prevented.

On the other hand, when emergency ejection is performed in the status where the OPU 104 is positioned on the inner peripheral side of the optical disk as shown in FIG. 5B, when the spindle motor 103 and the turn table 102 are moved to the bottom surface side of the device, as particularly shown in the enlarged view denoted by D in FIG. 5D, the bottom surface of the OPU 104 is projected to the bottom surface side of the device as described above. To prevent interference with the bottom case, it is necessary to determine the thickness of the device in consideration of the projection of the bottom surface of the OPU 104. This disturbs downsizing and thinning of the device.

As described above, according to the present embodiment, as the amount of movement of the OPU 104 to the bottom surface side of the device can be reduced upon emergency ejection, the projection can be reduced or prevented, and further, the problem of interference with the bottom case can be solved. This contributes to downsizing and thinning of the optical disk device.

Note that the present invention is not limited to the above-described embodiment. For example, the constituent elements 111a to 111c are screws having a coil spring and the lever 112 is a plate spring, however, other members having similar functions may be used.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disk device comprising:
an optical pickup unit that records/reproduces a signal;
a spindle motor that rotate-drives a disk-shaped recording medium;
a turn table, rotated by the spindle motor, that clamps the recording medium;
a slot loading mechanism that clamps the inserted recording medium on the turn table, or clamp-releases the recording medium from the turn table and ejects the recording medium to outside the device;
a first moving mechanism that rotatably moves the spindle motor and the turn table upward/downward;
a skew adjustment mechanism having a guide main shaft and a guide sub shaft to support the optical pickup unit;
a second moving mechanism that moves the optical pickup unit to a predetermined position on the recording medium; and
an armored case,
wherein the skew adjustment mechanism has a mechanism to mitigate interference between the optical pickup unit and the armored case, regardless of the position of the optical pickup unit, upon emergency ejection to eject the recording medium clamped on the turn table to the outside the device.

2. The optical disk device according to claim 1, wherein a support mechanism using a spring member is provided at shaft-holders in four positions of the guide main shaft and the guide sub shaft of the skew adjustment mechanism.

3. The optical disk device according to claim 2, wherein the spring member of the support mechanism in three positions is a coil spring, and the spring member in one position is a plate spring.

4. The optical disk device according to claim 3, wherein skew adjustment is performed by the support mechanisms having the coil spring as the spring member in the three positions.
